(19) United States
(12) Patent Application Publication
(10) Pub. No.: US 2009/0195526 A1
(43) Pub. Date: Aug. 6, 2009

(54) DRIVER INTEGRATED CIRCUIT FOR REDUCING COUPLING VOLTAGE AND LIQUID CRYSTAL DISPLAY DEVICE APPLYING THE SAME

(75) Inventors: Chien-Pin Chen, Tainan (TW); Biing-Seng Wu, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/025,216

(22) Filed: Feb. 4, 2008

(51) Int. Cl. G06F 3/038; G09G 3/36

(52) U.S. Cl. 345/211; 345/99

(57) ABSTRACT

A driver integrated circuit (IC) for driving a panel having pixels controlled by gate lines and data lines is disclosed, including a power circuit for generating a high level voltage and a low level voltage, a timing controller, a source driving circuit controlled by the timing controller to drive the data lines, a gate driving circuit controlled by the timing controller to selectively enable one of the gate lines for a line period. The gate driving circuit first asserts the selected gate line with the high level voltage in order to activate the corresponding pixels for receiving the driving signals from the corresponding data lines, and the gate driving circuit subsequently asserts the selected gate line with the low level voltage such that the corresponding pixels are still activated for receiving the driving signals. An LCD device utilizing the driver IC is also provided.

### BACKGROUND OF THE INVENTION

1. Field of the Invention

The invention relates to a liquid crystal display (LCD) and more particularly to a driver integrated circuit (IC) for driving a liquid crystal display (LCD) to reduce coupling voltage thereof and an LCD device applying the driver IC.

2. Description of the Related Art

A liquid crystal display (LCD) is widely used in various electronic equipments as a thin and light-weight flat display. Specifically, an active matrix type liquid crystal display apparatus using a switching element such as a thin film transistor (TFT) is being used in personal computer and liquid crystal TV due to its excellent image characteristics.

LCDs include a plurality of pixels arranged in a matrix, a plurality of data lines and a plurality of gate lines. Each pixel includes a switching element such as a TFT and a liquid crystal layer. Each switching element is connected to one of the gate lines and one of the data lines. The switching element is turned on upon receipt of a high state gate voltage from the gate line to transfer a data voltage from the data line to the liquid crystal layer. Alternatively, the switching element is turned off upon receipt of a low state gate voltage from the gate line to not transfer the data voltage.

FIG. 1 is an equivalent circuit diagram of a pixel in a conventional display device and FIG. 2 is a diagram showing typical waveforms of a gate voltage, a data voltage, and a pixel voltage. A liquid crystal layer, Clc, is connected between a pixel electrode 11 and a reference electrode 12. A data voltage Vd becomes a pixel voltage Vp after passing through a TFT 13 which is turned on by a high state Vgh of a gate voltage Vg. The voltage difference between the pixel voltage Vp generated at the pixel electrode 11 and a common voltage Vcom applied to the reference electrode 12 determines the transmittance of light.

Under the high state Vgh of the gate voltage Vg of the TFT 13, the pixel voltage Vp reaches the data voltage Vd. The pixel voltage Vp drops by as much as a coupling voltage Vk due to parasitic capacitor Cgd after the gate voltage Vg becomes low state Vgl. The coupling voltage Vk is determined by the following equation:

$$Vk = \frac{Cgd}{Cgd + Clc + Cs} \times Δ Vg ,$$

where Clc is the capacitance of the liquid crystal layer, Cgd is a parasitic capacitance between a gate and a drain of the TFT 13, and Cs is a storage capacitance connected in parallel to the capacitance Clc.

The magnitude of the coupling voltage Vk depends on the position of pixel, which shows drastic position dependency especially in the extension direction of the gate lines. A difference ΔVg between the high state Vgh and low state Vgl of the gate voltage, which determines the magnitude of the coupling voltage Vp, varies along the gate lines due to the delay of the gate signal. In detail, the coupling voltage has the largest value at the position at which the gate signal is applied, and it becomes smaller as it goes along the gate line because the signal delay of the gate signal increases.

One of the techniques for solving this problem is to apply a plurality of common voltages with different magnitudes to at least two points on the reference electrode. For example, the magnitude difference of the coupling voltage along the gate line is compensated by applying different common voltages at two points of the reference electrode, e.g., two opposite ends of the reference electrode in the row direction.

However, the capacitances of the capacitors Cgd, Clc and Cs are different for each panel due to variation in fabrication process, causing the coupling voltage to be different for each panel. Therefore, adjustment of the common voltage is required for each panel, making the fabrication process more difficult and expensive.

### BRIEF SUMMARY OF THE INVENTION

Accordingly, the invention solves the above mentioned problems and provides an LCD device with a reduced coupling voltage.

The invention also provides a driver IC employing a driving method for driving a display comprising pixels controlled by gate lines and data lines. The driver IC comprises a power circuit, a timing controller, a source driving circuit and a gate driving circuit. The power circuit generates a high level voltage and a low level voltage. The source driving circuit is controlled by the timing controller to drive the data lines. The gate driving circuit is controlled by the timing controller to selectively enable one of the gate lines for a line period. To selectively enable the gate line, the gate driving circuit first asserts the selected gate line with a high level voltage in order to activate the corresponding pixels for receiving the driving signals from the corresponding data lines. Subsequently, the gate driving circuit asserts the selected gate line with a low level voltage such that the corresponding pixels are still activated for receiving the driving signals.

The invention further provides an LCD device employing the driver IC. The LCD device comprises a plurality of data lines, a plurality of gate lines, a display comprising pixels controlled by the gate lines and the data lines, and the driver IC that comprises a power circuit, a timing controller, a source driving circuit and a gate driving circuit.

### BRIEF DESCRIPTION OF THE DRAWINGS

The invention can be better understood by reading the subsequent detailed description and examples with reference to the accompanying drawings, wherein:

FIG. 1 is an equivalent circuit diagram of a pixel in a conventional display device;

FIG. 2 is a diagram showing typical waveforms of FIG. 1;

FIG. 3 is a diagram explaining a driving method of an LCD according to the invention;

FIG. 4 is a diagram of typical waveforms of FIG. 3 in according to an embodiment of the invention;

FIGS. 5A and 5B are timing diagrams of gate voltages according to another embodiment of the invention;

FIGS. 6A and 6B are timing diagrams of gate voltages according to another embodiment of the invention;

FIG. 7 is a schematic diagram of an LCD device employing the driving method of FIGS. 3 and 4 in accordance with an embodiment of the invention;

FIG. 8 is a timing diagram of a high-level gate voltage and a low-level gate voltage according to an embodiment of the invention;

FIGS. 9A and 9B are timing diagrams of high-level gate voltages according to another embodiment of the invention; and

FIGS. 10A and 10B are timing diagrams of high-level gate voltages according to another embodiment of the invention.

### DETAILED DESCRIPTION OF THE INVENTION

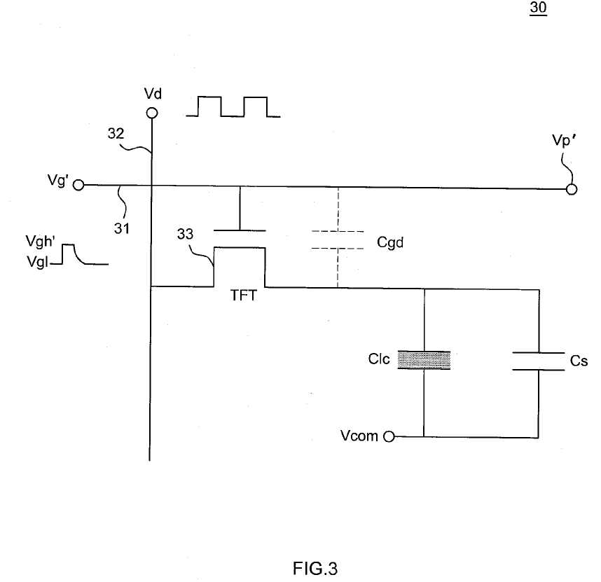

FIG. 3 is a diagram that explains a driving method of an LCD according to the invention, in which an equivalent circuit of only one pixel is shown for easy understanding purpose.

Referring to FIG. 3, a pixel 30 comprises a gate line 31 for applying a gate voltage Vg′, a data line 32 intersecting the gate line 31 for applying a data voltage Vd, and a thin film transistor (TFT) 33 arranged in a matrix form at the intersection region of the gate line 31 and the data line 32. In order to drive pixel 30, the gate voltage Vg′ is applied to the gate line 31 and the data voltage Vd is applied to the data line 32, wherein the gate voltage Vg′ comprises a high state Vgh′ for asserting the gate line 31 in order to activate the TFT 33, and a low state Vgl for de-asserting the gate line 31 in order to deactivate the TFT 33. The data voltage Vd passes through the TFT 33 and becomes a pixel voltage Vp′ when the TFT 33 is activated by the high state Vgh′ of the gate voltage Vg′. The voltage difference between the pixel voltage Vp′ and a common voltage Vcom applied to a liquid crystal capacitor Clc determines the transmittance of light. Since the common voltage Vcom has a fixed voltage or swings between two fixed voltages, the pixel voltage Vp′ essentially determines the light transmittance.

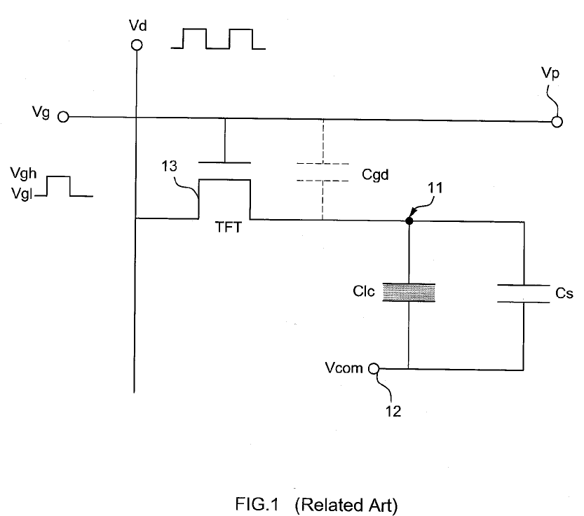

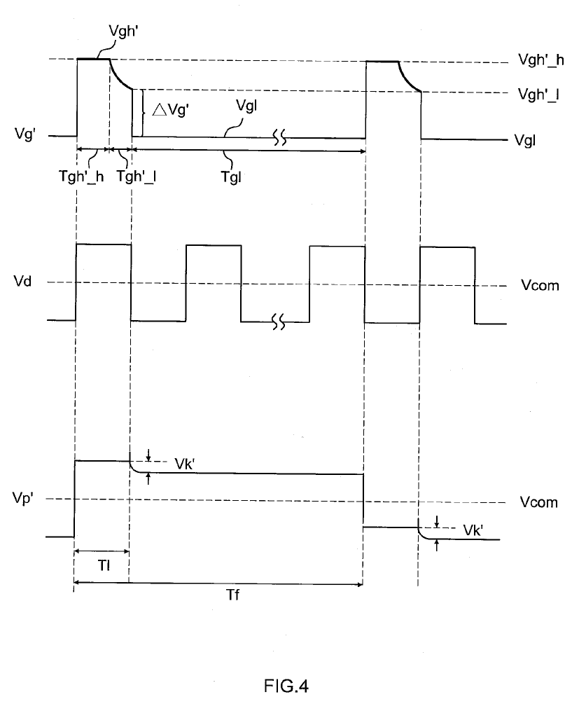

FIG. 4 is a diagram of waveforms of the gate voltage Vg′, the data voltage Vd and the pixel voltage Vp′ of FIG. 3. As shown, the gate voltage Vg′ has a cyclic period equal to a frame period Tf. Each cyclic period has the high state Vgh′ and the low state Vgl. The period Tgh′ of the high state Vgh′, equal to a line period T1, is divided into a high level period Tgh′_h and a low level period Tgh′_l. In the high level period Tgh′_h, the gate voltage Vg′ is fixed at a high level Vgh′_h to activate the TFT 33. In the low level period Tgh′_l, the gate voltage Vg′ is converged from the high level Vgh′_h to a low level Vgh′_l but the TFT 33 is still activated, wherein Vgh′_l is lower than Vgh′_h. During the high state Vgh′ of the gate voltage Vg′ of the TFT 33, the pixel voltage Vp′ reaches the data voltage Vd. Given Vgh′_h=Vgh of FIG. 1, ΔVg′=Vgh_l−Vgl is lower than ΔVg=Vgh−Vgl of FIG. 1.

In the period Tgl of the low state Vgl, the gate voltage Vg′ is fixed at a low-gate-voltage level Vgl. The pixel voltage Vp′ drops by a kickback voltage Vk′ due to parasitic capacitors Cgd after the gate voltage Vg′ is turned to the low state Vgl. The coupling voltage Vk′ is determined by the following equation:

$$Vk = \frac{Cgd}{Cgd + Clc + Cs} \times Δ {Vg}^{′} ,$$

where Clc is the capacitance of the liquid crystal layer, Cgd is a parasitic capacitance between a gate and a drain of the TFT 13, and Cs is a storage capacitance connected in parallel to the capacitance Clc

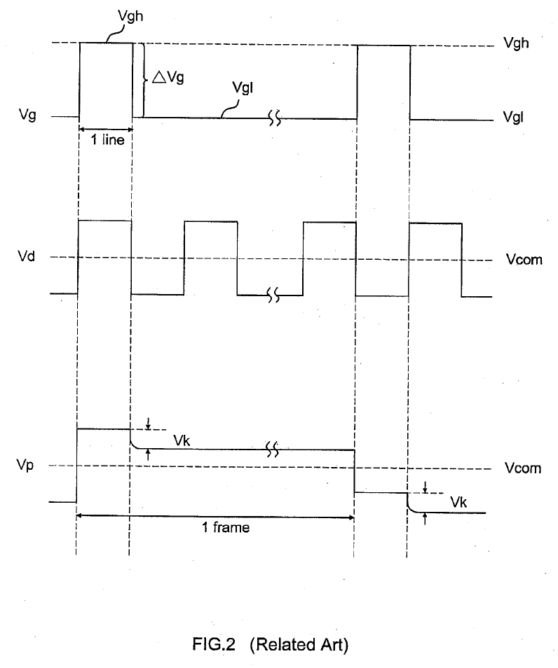

As clearly shown by the equation, the coupling voltage Vk′ is lower than the coupling voltage Vk of FIG. 1 because ΔVg′ in FIG. 4 is lower than ΔVg in FIGS. 1 and 2.

Note that the invention only requires ΔVg′ to be lower than ΔVg to reduce coupling voltage. That is, only the level Vgh_l at the end of the period Tgh′ is required to be lower than the level at the end of the period Tgh in FIG. 1 (or the level Vgh). The pattern of Vg′ in FIGS. 3 and 4 is illustrated only for explaining purpose and various other patterns of the high state Vgh can also be applicable.

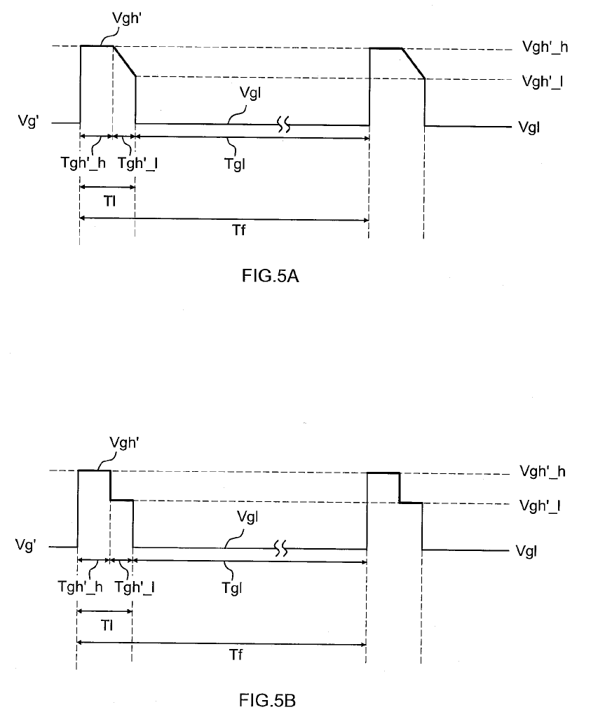

For example, in the embodiment shown in FIGS. 3 and 4, the gate voltage Vg′ in the low level period Tgh′_l is converged from the high level Vgh′_h to the low level Vgh′_l with a rate decreasing over time. FIGS. 5A and 5B illustrate two other embodiments of the gate voltage Vg′ with different patterns in the low level period Tgh′_l. As shown, the gate voltage Vg′ changes with a constant rate and fixed at the low level Vgh′_l during the low level period Tgh′_l in FIGS. 5A and 5B, respectively.

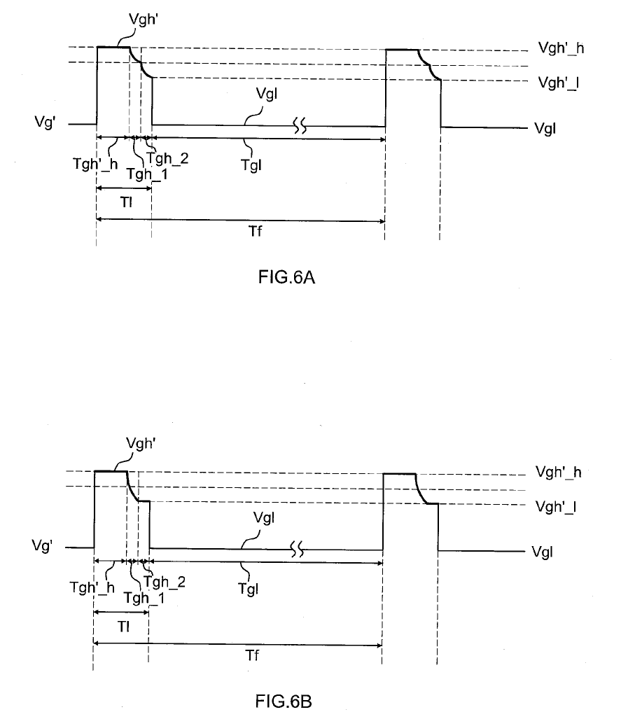

For another example, in the embodiment in FIGS. 3 and 4, the period Tgh′ is divided into two periods Tgh′_h and Tgh′_l. However, the period Tgh′ can be divided into more than two periods. FIGS. 6A and 6B illustrate two other exemplary embodiments of the gate voltage Vg′ both with the period Tgh′ divided into three periods Tgh′_h′, Tgh_l_l and Tgh_l_2.

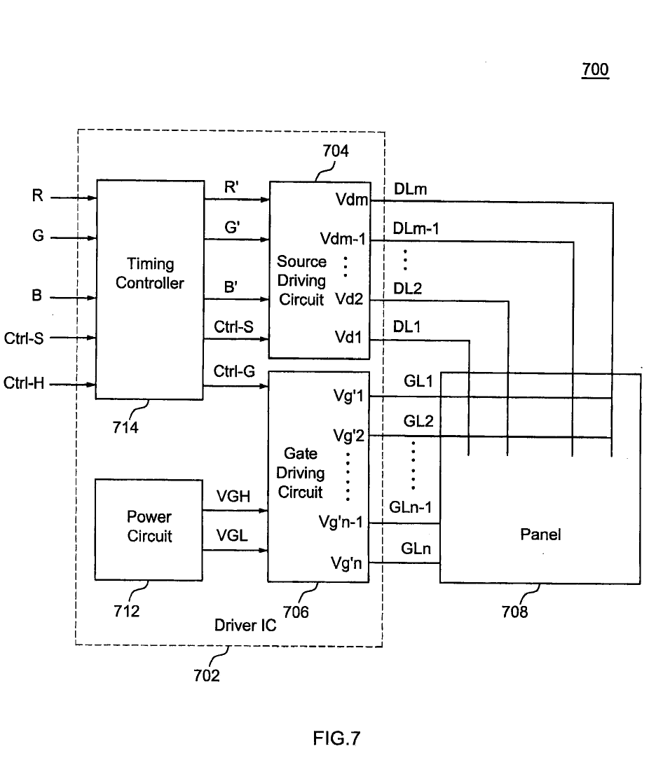

FIG. 7 is a schematic diagram of an LCD device 700 employing the driving method shown in FIGS. 3 and 4. As shown, the LCD device 700 comprises a driver IC 702, a plurality of data lines DL1-DLm and a plurality of gate lines GL1-GLn, and a panel 708. A source driving circuit 704, a gate driving circuit 706, a power circuit 712, and a timing controller 714 are all integrated into the driver IC 702. The driver IC 702 is employed to drive the display 708 through the data lines Dl1-DLm and the gate lines GL1-GLn. The panel 708 is constructed with a plurality of pixels each comprising a TFT. Each of the pixels is controlled by one of the gate lines GL1-GLn and one of the data lines DL1-DLm. Preferably, the panel 708 is a small to medium scaled display.

The timing controller 714 in the driver IC 702 is employed to receive image signals R, G and B, a control signal CTRL-S and a control signal CTRL-G from a host (not shown) and to convert the image signals R, G, B to image signals R′, G′ and G′ for transmission. The timing controller 714 then applies the image signals R′, G′, B′ and the control signal CTRL-S to the source driving circuit 704 and applies the control signal CTRL-G to the gate driving circuit 706.

The power circuit 712 in the driver IC 702 generates a high-level gate voltage VGH and a low-level gate voltage VGL and then applies them to the gate driving circuit 706.

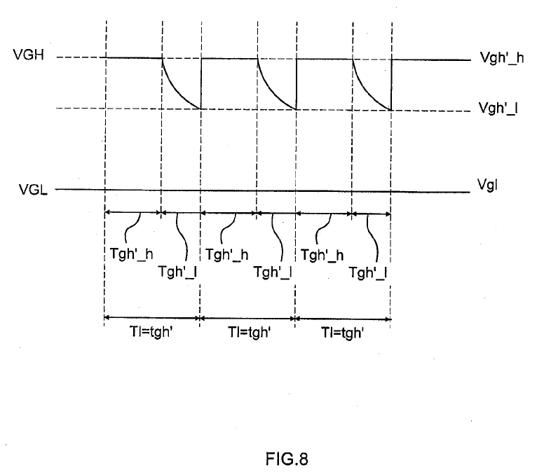

FIG. 8 is a timing diagram of the high-level gate voltage VGH and the low-level gate voltage VGL. As shown, the high-level gate voltage VGH has a cyclic period Tgh′ equals to a line period T1. Each of the period Tgh′ is divided into a high level period Tgh′_h and a low level period Tgh′_l. During the high level period Tgh′_h, the high-level gate voltage VGH is fixed at a high level Vgh′_h. During the low level period Tgh′_l, the high-level gate voltage VGH is converged from the high level Vgh′_h to a low level Vgh′_l. Unlike the high-level gate voltage VGH, the low-level gate voltage VGL is fixed at a low-gate-voltage level Vgl.

The source driving circuit 704 generates data voltages Vd1 to Vdm according to the video signals R′, G′ B′, wherein the data voltages Vd1 to Vdm are all synchronized with the control signal CTRL-S received from the timing controller 714. The source driving circuit 704 then applies the data voltages Vd1 to Vdm respectively to the data lines DL1 DLm.

Meanwhile, the gate driving circuit 706 employs the high-level gate voltage VGH and the low level gate voltage VGL to generate gate voltages Vg′1 to Vg′n that are synchronized with the vertical synchronizing signal V received from the timing controller 714 for sequentially selecting/asserting the gate lines GL1 to GLn each for a line period T1. A plurality of TFT's connected to the selected gate line are turned on to receive data voltages Vd1 to Vdm from the source driving circuit 704, thereby displaying the video signals R′, G′ B′ on the panel 708.

By employing the high-level gate voltage VGH and the low level gate voltage VGL having the waveforms illustrated in FIG. 8, the gate driving circuit 706 generates gate voltages Vg′(1) to Vg′(n) each having relationship with the data voltages Vd(1) to Vd(m) and the pixel voltage as illustrated in FIG. 3. As such, each pixel of the panel 708 has a coupling voltage Vk′ lower than the coupling voltage Vk of FIG. 1.

It is also noted that the invention only requires that the level Vgh_l at the end of the period Tgh′ of FIG. 8 be lower than the level at the end of the period Tgh in FIG. 1 (or the level Vgh). Various patterns of the high-level gate voltages VGH can satisfy this requirement.

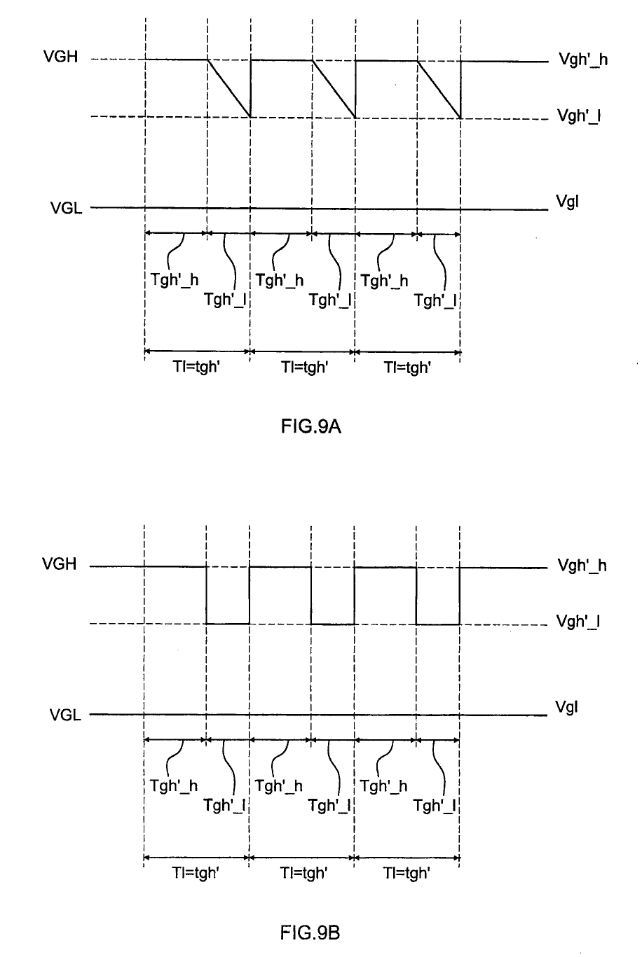

For example, in the embodiment shown in FIG. 8, the high-level gate voltage VGH in the low level period Tgh′_l is converges from the high level Vgh′_h to the low level Vgh′_l with a rate decreasing over time. FIGS. 9A and 9B illustrate two other exemplary embodiments of high-level gate voltage VGH with different patterns in the low level period Tgh′_l. As shown, the high-level gate voltage VGH changes with a constant rate and fixed at the low level Vgh′_l in the low level period Tgh′_l in FIGS. 9A and 9B, respectively.

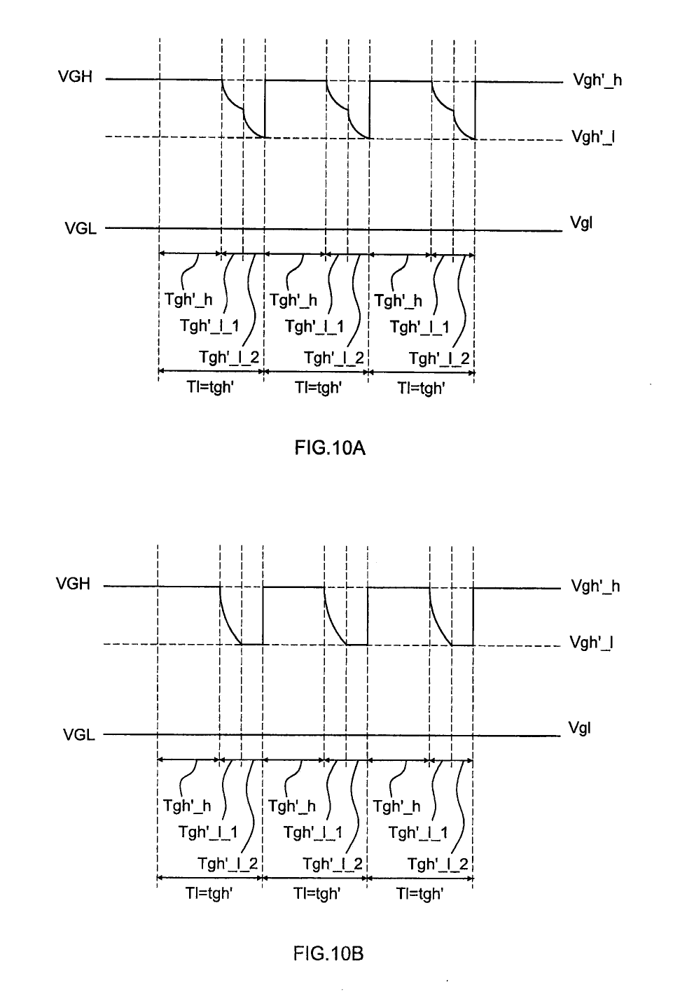

In other embodiments in the figure, the period Tgh′ can be divided into more than two periods. FIGS. 10A and 10B illustrate two other exemplary embodiments of the high-level gate voltage VGH both with the cyclic period Tgh′ divided into three periods Tgh′_h′, Tgh_l_l and Tgh_l_2.

With the implementation of the power circuit 712 providing a novel pattern of a high gate voltage Vgh′ to decrease the voltage difference between high and low states of gate voltages, coupling voltages are reduced. Furthermore, the power circuit 712 can be easily combined with the timing controller 714 in the driver IC 702. Accordingly, the LCD device of the invention has high integration degree but low coupling voltage.

While the invention has been described by way of examples and preferred embodiments, it is to be understood that the invention is not limited thereto. The scope of the appended claims should be accorded with the broadest interpretation so as to encompass all other modifications and similar arrangements.

What is claimed is:

1. A driver integrated circuit (IC) for driving a panel having pixels controlled by gate lines and data lines, comprising:
a power circuit that generates a high level voltage and a low level voltage;
a timing controller;
a source driving circuit controlled by the timing controller to drive the data lines; and
a gate driving circuit controlled by the timing controller to selectively enable one of the gate lines for a line period, wherein the gate driving circuit first asserts the selected gate line with the high level voltage in order to activate the corresponding pixels for receiving the driving signals from the corresponding data lines, and the gate driving circuit subsequently asserts the selected gate line with the low level voltage such that the corresponding pixels are still activated for receiving the driving signals.

2. The driver IC of claim 1, wherein the gate driving circuit asserts the selected gate line with the low level voltage at the end of the line period.

3. The driver IC of claim 1, wherein the high level voltage is converged to the low level voltage when the gate driving circuit asserts the selected gate line with the low level voltage.

4. The driver IC of claim 1, wherein the low level voltage remains unchanged when the gate driving circuit asserts the selected gate line with the low level voltage.

5. The driver IC of claim 3, wherein the low level voltage is converged at a constant rate.

6. The driver IC of claim 3, wherein the low level voltage is converged at a time-varying rate.

7. A liquid crystal display (LCD) device, comprising
a plurality of data lines;
a plurality of gate lines;
a panel comprising pixels controlled by the gate lines and the data lines; and
a driver IC that drives the panel and comprising:
a power circuit that generates a high level voltage and a low level voltage; and
a timing controller;
a source driving circuit controlled by the timing controller to drive the data lines; and
a gate driving circuit controlled by the timing controller to selectively enable one of the gate lines for a line period, wherein the gate driving circuit first asserts the selected gate line with the high level voltage in order to activate the corresponding pixels for receiving the driving signals from the corresponding data lines, and the gate driving circuit subsequently asserts the selected gate line with the low level voltage such that the corresponding pixels are still activated for receiving the driving signals.

8. The LCD device of claim 7, wherein the gate driving circuit asserts the selected gate line with a low level voltage at the end of the line period.

9. The LCD device of claim 7, wherein the high level voltage is converged to the low level voltage when the gate driving circuit asserts the selected gate line with the low level voltage.

10. The LCD device of claim 7, wherein the low level voltage remains unchanged when the gate driving circuit asserts the selected gate line with the low level voltage.

11. The LCD device of claim 9, wherein the low level voltage is converged at a constant rate.

12. The LCD device of claim 9, wherein the low level voltage is converged at a time-varying rate.
